(19) United States
(12) Patent Application Publication
(10) Pub. No.: US 2011/0243785 A1
(43) Pub. Date: Oct. 6, 2011

(54) PRECURSOR FOR THE PRODUCTION OF SINTERED METALLIC COMPONENTS, A PROCESS FOR PRODUCING THE PRECURSOR AND THE PRODUCTION OF COMPONENTS

(75) Inventors: Ulf Waag, Bad Saeckingen (DE); Peter Leute, Albbruck-Buch (DE)

(73) Assignee: H.C STARCK GMBH, Goslar (DE)

(21) Appl. No.: 13/133,670

(22) PCT Filed: Nov. 13, 2009
(86) PCT No.: PCT/EP09/65129

§ 371 Date: Jun. 9, 2011

(30) Foreign Application Priority Data
Dec. 11, 2008 (DE) 102008062614.7

(51) Int. Cl. B22F 3/12; B32B 5/16; B32B 15/02; B05D 1/02

(52) U.S. Cl. 419/23; 428/403; 428/570; 427/424

(57) ABSTRACT

A precursor for the production of a sintered metallic component includes a core comprising one particle of a first metallic powder having a particle size d₉₀ of at least 50 μm. A shell layer is disposed on the core. The shell layer comprises a binder and a second powder having a particle size d₉₀ of less than 25 μm. The precursor is powdered.

### CROSS REFERENCE TO PRIOR APPLICATIONS

This application is a U.S National Phase application under 35 U.S.C. §371 of International Application No. PCT/EP2009/065129, filed on Nov. 13, 2009 and which claims benefit to German Patent Application No. 10 2008 062 614.7, filed on Dec. 11, 2008. The International Application was published in German on Jun. 17, 2010 as WO 2010/066529 A1 under PCT Article 21(2).

### FIELD

The present invention provides a precursor (intermediate, pre-product) for producing sintered metallic components, a process for producing the precursor and the production of the components.

### BACKGROUND

Powders are used for producing sintered metallic components (parts), the powders usually being formed by the respective metal and normally by the metal alloy from which a component is to be produced. In the production of the components, a significant influence can be exerted by the choice and pre-treatment of the starting powder which determine the properties of the component. The particle size of the powder used therefore has a strong influence on the achievable physical density of the component material and the shrinkage during sintering.

In the past, the sintering activity was in particular improved by a prior high-energy milling step so as to also improve the properties of the component material.

The metal powders used must also meet other requirements. In processing to produce green bodies, good flowability of the powders, an increased green density and green strength of the green bodies before sintering are desired. If relatively high green densities of the green bodies are achieved in shaping by pressing, the shrinkage which occurs on the fully sintered component is reduced. However, a very low shrinkage is desirable in order to be able to produce strongly contoured components and also to avoid having to carry out refinishing.

Highly alloyed metallic powders cannot be processed by simple powder-metallurgical technologies such as pressing and sintering to form sintered components because of their hardness. High-energy milling of such alloy powders and subsequent agglomeration makes such powders, for example, pressable. However, poorer technological parameters such as low apparent density, poor flow behavior and high shrinkage during sintering must be accepted alongside the increased sintering activity. Because of these disadvantageous properties, it is not possible to produce high-density components without considerable mechanical refinishing.

Sintered components produced in a conventional way achieve physical densities which are not more than 95% of the theoretical density and have a shrinkage of at least 10%.

### SUMMARY

An aspect of the present invention is to provide methods of producing sintered metallic components which provide an increased physical density and a reduced shrinkage on the fully sintered component.

In an embodiment, the present invention provides a precursor for the production of a sintered metallic component which includes a core comprising one particle of a first metallic powder having a particle size d₉₀ of at least 50 μm. A shell layer is disposed on the core. The shell layer comprises a binder and a second powder having a particle size d₉₀ of less than 25 μm. The precursor is powdered.

### DETAILED DESCRIPTION

The present invention provides advantageous processes of producing sintered metallic components. In an embodiment of the present invention, a pulverulent precursor is used that is, in place of the metal powders previously used, subjected to shaping and sintering.

The precursor comprises cores enclosed by a shell layer. They are produced using a first powder and a second powder which differ at least in terms of their particle size. The particles of the first powder which form the cores are therefore larger and have a particle size d₉₀ of at least 50 μm, for example, at least 80 μm. This is a metal or a metal alloy.

The particles of the second powder are smaller and have a particle size d₉₀ of less than 25 μm, for example, less than 20 μm, and are, for example, smaller than 10 μm. The shell layer additionally contains a binder. This can, for example, be an organic binder. It is possible to use, for example, polyvinyl alcohol (PVA) as binder. The second powder can be a metal, a metal alloy or a metal oxide. However, it can also be a mixture comprising at least two of these components. Carbon can additionally be present in the form of graphite.

In the simplest case, the particles of the first powder and of the second powder are formed by the same metal or the same metal alloy. However, for the two powders, it is advantageous to use different metals, metal alloys or in the case of the second powder, a metal oxide. This provides the opportunity of at the same time also achieving alloy formation or, as a result of concentration equilibration of alloy constituents, an altered alloy composition in the finished component material during the sintering step carried out for producing a finished component.

It is advantageous in the further processing in the production of green bodies and the finished components for the second powder to be more ductile than the first powder. As a result, during pressing for producing green bodies by means of a shaping process, an increased green density can be achieved which finally also results in a higher physical density of the component after sintering and in reduced shrinkage. The shell layer performs a function which is analogous to that of pressing aids.

In a precursor, the individual particles of the precursor should have been produced so that the shell layer has a proportion by mass which is not more than the proportion by mass of a core. The proportion of binder in the shell layer can thereby be discounted or be ignored. The proportion by mass of the cores should, however, be greater than that of shell layers. Shell layers should also have the same layer thicknesses, which should apply to the individual particles and also to all particles of the precursor.

In an embodiment of the present invention, the precursors can be produced by projecting (spraying) a suspension on the particles of the first powder. The suspension contains particles of the second powder and the binder. It is thereby possible to use an aqueous suspension. During spraying, the particles of the first powder are kept in motion. This can be carried out using, for example, a fluidized-bed rotor.

The particles of the precursor can be dried after a prescribed thickness of the shell layers has been formed on the core by particles of the first powder. It is thereby possible to achieve a high apparent density of about 40% of the theoretical density and good flowability which can be less than 30 s, as determined by a Hall flow funnel.

Pre-sintering of the precursor can also be carried out. This makes it possible to exert a greater influence on the properties of the precursor as far as its apparent density (filling density) and the flowability are concerned. The apparent density can thereby be increased and the flowability can be improved. Flowability can thereby be reduced, for example, from 40 s to 30 s, when pre-sintering is carried out at a temperature of at least 800° C. as determined by a Hall flow funnel. The physical density of the fully sintered component can also thereby be increased and the shrinkage can also be reduced to below 5%.

The precursor can then be subjected to shaping. Pressing forces which lead to compaction are thereby applied. The green bodies obtained achieve an increased green density and green strength. The components mainly present in the shell layer are deformed during pressing. The cores normally remain undeformed. The deformation of the shell layer enables increased compaction to be achieved, which leads to a reduction in the shrinkage during sintering. This can be kept below 8%. A reduction to 5% and below is also possible. The physical density of a fully sintered component can reach at least 92% and up to or above 95% of the theoretical density.

As set forth above, alloy formation or an altered alloy composition can occur during sintering. A concentration equilibration between the two powders used for the cores and the shell layer thereby takes place if these have a different consistency and/or composition. Diffusion processes can be exploited. The longest diffusion path is thereby 0.5 times the particle diameter of the precursor. The time required for diffusion can be significantly reduced compared to conventional production processes. This also applies in comparison to the use of diffusion-bonded powders in which, for example, particles of nickel or molybdenum are sintered onto particles of pure iron. Only a very small proportion of alloying elements in the range from 0.1 to 2% can, however, be achieved in this way. In contrast, much higher alloyed component materials can be obtained by means of the present invention. In comparison to the known technical solutions, the consistency of an alloy produced according to the present invention by sintering can be established precisely and reproducibly.

Various iron-, cobalt- and nickel-based alloys can be produced in this way. The proportion of the respective base metal is at least 50% by mass.

The present invention is hereinafter illustrated by various examples.

### Example 1

A component was produced in which the component material was a 5.8W 5.0Mo 4.2Cr 4.1V 0.3Mn 0.3Si 1.3C iron alloy.

An iron-based alloy containing 8.1W 6.7Mo 5.9Cr 0.4Mn 0.4Si was used for the first powder forming the cores of the precursor. The particle size d90 was 95 μm.

A second powder which was a mixture of 31.0% by mass of carbonyl iron powder and 1.3% by mass of partially amorphous graphite, both having a respective particle size d₉₀ of less than 10 μm was used for the shell layer. A proportion by mass for the cores of 67.7% by mass and for the shell layer without binder of 32.3% by mass were obtained in this way.

The carbonyl iron was used in reduced form, but can also be used in unreduced form.

The first powder was first introduced into a fluidized-bed rotor and agitated therein. A suspension formed by water, PVA and the powder mixture for the shell layer was sprayed in through a two-fluid nozzle arranged tangentially to the direction of rotation of the rotor. The formation of the shell layer around the cores was performed to occur very slowly. The composition of the suspension was 38% by mass of water, 58% by mass of carbonyl iron powder, 2.4% by mass of partially amorphous graphite and 1.8% by mass of binder (PVA).

After drying, the pulverulent precursor had a particle size d₉₀ of 125 μm.

Shaping was subsequently carried out by pressing to achieve compaction and the formation of a green body. This can be carried out using customary shaping processes such as die pressing in tools, injection molding or extrusion. A green density of 6.9 g/cm³ and a green strength of 10.3 MPa was achieved.

The green body was then sintered under forming gas (10% by volume of H₂ and 90% by volume of N₂). The heat treatment was carried out in stages at 250° C., 350° C., and 600° C., with a respective hold time of 0.5 h at each of those temperatures. The maximum temperature of 1200° C. was maintained for 2 h.

The fully sintered component had a physical density of 7.95 g/cm³ and the shrinkage after sintering was 4.6%. The theoretical density of this material is 7.97 g/cm³.

### Example 2

A component composed of an iron-based alloy 34.0Cr 2.1Mo 2.0Si 1.3C, balance iron, was produced using a first powder for the cores comprising an alloy 51.5Cr 3.6Mo 2.7Si 0.68Mn 1.9C, balance iron, and having a particle size d₉₀ of 82 μm.

For the second powder, an unreduced carbonyl iron powder (particle size d₉₀ 9 μm) as variant 1 and iron powder obtained from reduced iron oxide (particle size d₉₀ 5 μm) as variant 2 were employed.

The proportion by mass of the first powder was 66.7% and that for the second powder was 33.3% by mass in each case.

The first powder was first introduced into a fluidized-bed rotor and agitated therein. A suspension formed by water, PVA and the powder mixture for the shell layer was sprayed in through a two-fluid nozzle arranged tangentially to the direction of rotation of the rotor. The formation of the shell layer around the cores was performed to occur very slowly. The suspension had a composition of 49% by mass of water, 49% by mass of the second powder and 2% by mass of binder (PVA).

The precursor according to variant 1 had an apparent density of 2.2 g/cm³ and a flow time determined by means of a Hall flow funnel of 36 s. In the case of the precursor according to variant 2, an apparent density of 2.4 g/cm³ was achieved and a flow time of 33 s could be determined.

Shaping was subsequently carried out by pressing to achieve compaction and the formation of a green body. This can be carried out using customary shaping processes such as die pressing in tools, injection molding or extrusion.

A green body according to variant 1 achieved a green density of 5.3 g/cm³ and a green strength of 3.8 MPa. A green body according to variant 2 achieved a green density of 5.4 g/cm³ and a green strength of 5.0 MPa.

The green body of both variants was then sintered under forming gas (10% by volume of H₂ and 90% by volume of N₂). A stepped temperature regime with a hold time of 0.5 h at each of the temperatures 250° C., 350° C. and 600° C. was employed. Final sintering was subsequently carried out at 1250° C. over a period of 2 h.

The fully sintered component had, in the case of variant 1, a physical density of 7.1 g/cm³ and the shrinkage after sintering was 7.6%. In the case of variant 2, the fully sintered component had a physical density of 6.9 g/cm³ and a shrinkage of 6.3%. The theoretical density of the material is 7.35 g/cm³.

### Example 3

A component having a target alloy as cobalt-based alloy having the composition 27.6Mo 8.9Cr 2.2Si, balance cobalt, was produced using a first water-atomized powder of an alloy of 27.6Mo 8.9Cr 2.2Si, balance cobalt, having a particle size d₉₀ of 53.6 μm and a second powder of an alloy 27.6 Mo 8.9 Cr 2.2 Si, balance cobalt, having a particle size d₉₀ of 21 μm. Both powders were used in an amount of 50% by mass for producing the precursor. The suspension had a composition of 29% by mass of water, 69% by mass of the second powder, 1% by mass of paraffin and 1.4% by mass of binder (PVA).

The first powder was first introduced into a fluidized-bed rotor and agitated therein. A suspension formed by water, PVA and the powder mixture for the shell layer was sprayed in through a two-fluid nozzle arranged tangentially to the direction of rotation of the rotor. The formation of the shell layer around the cores was performed to occur very slowly.

After drying, the pulverulent precursor had a particle size d₉₀ of 130 μm. The apparent density was 3.0 g/cm³ and a flow time of 29 s was determined by a Hall flow funnel.

Shaping was subsequently carried out by pressing to achieve compaction and the formation of a green body. This can be carried out using customary shaping processes such as die pressing in tools, injection molding or extrusion. A green density of 6.4 g/cm³ was achieved.

The green body was then sintered in a hydrogen atmosphere using the following parameters:

A heat treatment was carried out in stages at temperatures of 250° C., 350° C. and 600° C. with a respective hold time of 0.5 h, and a subsequent increase in the temperature to 1285° C. The maximum temperature was maintained for 2 h.

The fully sintered component had a physical density of 8.7 g/cm³ and the shrinkage after sintering was 10.2%.

The present invention is not limited to embodiments described herein; reference should be had to the appended claims.

1-16. (canceled)

17. A precursor for the production of a sintered metallic component, the precursor comprising:
a core comprising one particle of a first metallic powder having a particle size d₉₀ of at least 50 μm; and
a shell layer disposed on the core, the shell layer comprising a binder and a second powder having a particle size d₉₀ of less than 25 μm,
wherein the precursor is powdered.

18. The precursor as recited in claim 17, wherein the second powder has a particle size d₉₀ of less than 20 μm.

19. The precursor as recited in claim 17, wherein the second powder has a particle size d₉₀ of less than 10 μm.

20. The precursor as recited in claim 17, wherein the first metallic powder has a particle size d₉₀ of at least 80 μm.

21. The precursor as recited in claim 17, wherein the core is a metal or a metal alloy.

22. The precursor as recited in claim 17, wherein the shell layer is at least one of a metal, a metal alloy and a metal oxide.

23. The precursor as recited in claim 19, wherein a proportion by mass of the at least one of a metal, a metal alloy and a metal oxide in the shell layer is ≦a proportion by mass of the one particle of the first metallic powder comprising the core.

24. The precursor as recited in claim 17, wherein the shell layer further comprises carbon.

25. The precursor as recited in claim 24, wherein the carbon is a partially amorphous graphite.

26. The precursor as recited in claim 17, wherein a ductility of the second powder is higher than a ductility of the first metallic powder.

27. A process for producing a powdered precursor comprising a core comprising one particle of a first metallic powder having a particle size d₉₀ of at least 50 μm and a shell layer disposed on the core, the shell layer comprising a binder and a second powder having a particle size d₉₀ of less than 25 μm, the process comprising:
preparing a suspension comprising the second powder and the binder; and
coating the first metallic powder with the suspension so as to form the shell layer comprising the binder and the second powder on the first metallic powder.

28. The process as recited in claim 27, wherein the second powder is at least one of a metal, a metal alloy and a metal oxide.

29. The process as recited in claim 27, wherein the first metallic powder and the second powder form a metal alloy during a sintering.

30. The process as recited in claim 27, wherein the coating is performed by spraying and further comprising:
agitating the first metallic powder during the spraying; and
drying the powdered precursor after a predetermined thickness of the shell layer is obtained.

31. A process for producing a sintered metallic component with a powdered precursor comprising a core comprising one particle of a first metallic powder having a particle size d₉₀ of at least 50 μm and a shell layer disposed on the core, the shell layer comprising a binder and a second powder having a particle size d₉₀ of less than 25 μm, the process comprising:
providing a dry powdered precursor;
shaping the powdered precursor with at least a compaction step so as to obtain a green body; and
sintering the green body so as to provide the sintered metallic component.

32. The process as recited in claim 31, wherein the shell layer comprises a metal oxide and the sintering is performed in a reducing atmosphere.

33. The process as recited in claim 31, wherein the sintering forms a metal alloy from first metallic powder and the second powder.

34. The process as recited in claim 33, wherein the metal alloy is formed by a diffusion processes during the sintering.

35. The process as recited in claim 31, wherein the powdered precursor is produced by:
preparing a suspension comprising the second powder and the binder, and
coating the first metallic powder with the suspension so as to form the shell layer on the first metallic powder,
wherein the coating, the shaping and the sintering are performed so as to obtain a shrinkage after the sintering of <8% and a density of >92% of a theoretical density.

36. The process as recited in claim 31, wherein the process is performed so as to provide an iron-based alloy, a cobalt-based alloy or a nickel-based alloy sintered metallic component.
